(19) United States
(12) Patent Application Publication
(10) Pub. No.: US 2009/0286135 A1
(43) Pub. Date: Nov. 19, 2009

(54) LIQUID SUPPLY CONTAINER AND FUEL CELL SYSTEM WITH SAME

(75) Inventors: Hidekazu Kimura, Minato-ku (JP); Suguru Watanabe, Minato-ku (JP); Toru Takahashi, Sagamihara-shi (JP); Nobuo Katsura, Yokohama-shi (JP); Minoru Murata, Chuo-ku (JP); Kiyoshi Isobe, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku (JP)

(21) Appl. No.: 12/307,238

(22) PCT Filed: Jul. 4, 2007
(86) PCT No.: PCT/JP2007/063761

§ 371 Date: Feb. 9, 2009

(30) Foreign Application Priority Data
Jul. 5, 2006 (JP) 2006-186028

(51) Int. Cl. H01M 2/02; B65D 90/02

(52) U.S. Cl. 429/34; 220/660

(57) ABSTRACT

A liquid supply container is provided which includes a liquid storage portion (11) for storing liquid therein, having a pair of side walls (13A and 13B) arranged to face each other. The liquid storage portion has a supply port (12) arranged on a wall different from the pair of side walls for supplying the liquid to an object. Each of the side walls of the liquid storage portion has a gusseted structure. A rigid member (18A, 19A, 18B, 19B) is arranged between a fold line (15A, 15B) of the gusseted structure and an edge (16A, 17A, 16B, 17B) substantially parallel to the fold line.

### TECHNICAL FIELD

The present invention relates to a liquid supply container for storing various types of liquid such as liquid fuel for use in a fuel cell or the like, and for supplying the stored liquid to a liquid acceptor, and the present invention also relates to a fuel cell system with such a liquid supply container.

### BACKGROUND ART

Liquid supply containers designed to store liquid and to supply the stored liquid to liquid acceptors of various equipment are widely used, for example, in various equipment using liquid fuel such as a fuel cell system or in medicinal solution administration. Such liquid supply containers are advantageous in that the liquid supply containers themselves can be replaced if liquid to be supplied becomes short, and thus the liquid can be supplied safely and yet easily, practically without dirtying hands. These liquid supply containers are particularly effective means when used for storing such liquid that may impose health hazards or that may significantly deteriorate when exposed to ambient air.

Recently, development of fuel cells for generating power using liquid as fuel has been progressed. Direct methanol fuel cells (DMFC) using methanol as fuel, in particular, have been ardently developed by many electric-appliance manufacturers. For example, DMFCs are expected as next-generation cells for use in laptop computers, various portable electronic equipment, and cellular phones. However, methanol generally poses significant health hazards, affecting central nerves to cause dizziness or diarrhea. Moreover, methanol is a high-risk and hazardous liquid which may damage the optic nerve if inhaled in large amount or splashed into the eye, likely resulting in vision loss. Therefore, it is believed for DMFCs that optimal means for supplying methanol as fuel to general consumers safely and easily is to use a cartridge type liquid supply container so as to eliminate the need of directly handling methanol, and such containers have been developed widely (see, for example, Japanese Laid-Open Patent Publication Nos. 2003-30887 and H08-12301).

In such liquid supply containers, a pump or the like is usually employed in order to efficiently feed liquid stored in its liquid storage portion to a liquid receptor.

Further, fuel containers (liquid supply containers) for use in fuel cell mechanisms have been proposed which are provided with means for changing the capacity of a fuel chamber in association with the internal pressure of the fuel chamber, so that this means generates a pressure required for pushing out fuel from the fuel chamber to a mechanism consuming the fuel without using a pump (see, for example, Japanese Laid-Open Patent Publication No. 2000-314376).

Further, bags with a gusseted structure are also proposed which are designed such that a front face film and/or a rear face film has higher rigidity than that of a film in the gusset-folded portion for controlling the container shape retention or the container shape during discharge of the liquid (see, for example, Japanese Laid-Open Patent Publication No. 2005-145549).

### DISCLOSURE OF THE INVENTION

However, according to the prior art method using a pump or the like for the purpose of efficiently supplying liquid stored in the liquid storage portion of the liquid supply container to the liquid receptor, the suction force of the pump must be enhanced as the internal pressure in the liquid storage portion drops if the shape of the liquid storage portion is difficult to deform (shrink) along with reduction of the liquid contained in the liquid storage portion due to supply (consumption) of the liquid. Thus, increased power consumption is required to increase the rotational speed and torque of the pump.

As for the liquid supply container described in Japanese Laid-Open Patent Publication No. 2000-314376 which is designed to push out fuel from the fuel chamber without using a pump, it is desired to reduce the amount of liquid remaining in the liquid storage portion of the liquid supply container after completing the supply of the liquid to the liquid receptor and to improve the efficiency of the supply of the liquid to the liquid receptor.

In the case of the container (bag) described in Japanese Laid-Open Patent Publication No. 2005-145549, although the shape of the front face film and/or the rear face film having high rigidity can be retained, the shape of the side wall films, which are folded when the internal volume of the container is reduced, cannot be controlled and hence the side wall films are possibly not folded correctly. This may result in not being able to reduce the internal volume of the container appropriately.

It is also desired for the liquid supply containers to increase the ratio of capacity of the liquid storage portion where liquid is stored to that of the entire liquid supply container (to store a greater amount of liquid for the external shape).

It is therefore an object of the present invention to provide a liquid supply container capable of suppressing the variation in pressure within a liquid storage portion when supplying liquid stored in the liquid storage portion to a liquid receptor.

It is another object of the present invention to provide a liquid supply container capable of reducing the amount of liquid remaining in a liquid storage portion after finishing the supply of the liquid to a liquid receptor.

It is still another object of the present invention to provide a fuel cell system employing the liquid supply container as described above.

According to a first aspect of the present invention, there is provided a liquid supply container which includes a liquid storage portion for storing liquid therein having a pair of side walls arranged to face each other, and a supply port provided in the liquid storage portion for supplying the liquid stored in the liquid storage portion to an object, wherein each of the pair of side walls has a gusseted structure, a rigid member is arranged between a fold line of the gusseted structure of the each of the pair of side walls and an edge substantially parallel to the fold line, and the supply port is provided in a wall different from the pair of side walls of the liquid storage portion.

According to a second aspect of the present invention, there is provided a fuel cell system including the liquid supply container as described above, liquid fuel stored in the liquid supply container, and a fuel cell for generating power by using the liquid fuel supplied from the liquid supply container.

### EFFECTS OF THE INVENTION

According to an example of a liquid supply container according to the present invention, the internal volume of a liquid storage portion is reduced when supplying liquid stored in the liquid storage portion to an object, whereby variation in pressure within the liquid storage portion can be suppressed. When completing the supply of the liquid stored in the liquid storage portion to the object, the space in the liquid storage portion where the liquid can be contained has been reduced, and thus the amount of the liquid remaining in the liquid storage portion can be reduced. Accordingly, the use of this liquid supply container for a fuel cell system reduces not only the power required to supply liquid fuel stored in the liquid storage portion to a fuel cell, but also the wasteful use of the liquid fuel.

### BRIEF DESCRIPTION OF THE DRAWING

FIG. 1 is a perspective view of a liquid supply container according to a first embodiment of the present invention, showing a state in which the inside of a liquid storage portion is fully filled with liquid:

FIG. 2 is a side view of the liquid supply container shown in FIG. 1;

FIG. 3 is a front view of the liquid supply container shown in FIG. 1;

FIG. 4 is a perspective view of the liquid supply container according to the first embodiment of the present invention, showing a state in which about a half of the liquid stored in the liquid storage portion has been consumed;

FIG. 5 is a front view of the liquid supply container shown in FIG. 4;

FIG. 6 is a cross-sectional view taken along the line VI-VI in FIG. 4;

FIG. 7 is a perspective view of the liquid supply container according to the first embodiment of the present invention, showing a state in which further liquid stored in the liquid storage portion has been consumed;

FIG. 8 is a schematic diagram of a fuel cell system provided with the liquid supply container according to the first embodiment of the present invention;

FIG. 9 is a cross-sectional view similar to FIG. 6 but of a second embodiment of the present invention, showing a state in which about a half of the liquid stored in the liquid storage portion has been consumed;

FIG. 10 is a cross-sectional view of a liquid supply container according to another embodiment of the present invention, showing a state in which the inside of a liquid storage portion is fully filled with liquid;

FIG. 11 is a cross-sectional view of a liquid supply container according to still another embodiment of the present invention, showing a state in which about a half of the liquid stored in the liquid storage portion has been consumed;

FIG. 12 is a cross-sectional view of a liquid supply container according to still another embodiment of the present invention, showing a state in which about a half of the liquid stored in the liquid storage portion has been consumed;

FIG. 13 is a cross-sectional view similar to FIG. 6 but of a liquid supply container according to a third embodiment of the present invention, showing a state in which about a half of liquid contained in a liquid storage portion has been consumed; and

FIG. 14 is a cross-sectional view showing a modification of the third embodiment of the present invention.

### BEST MODE FOR CARRYING OUT THE INVENTION

With reference to the drawing, description will be made about a liquid supply container according to exemplary embodiments of the present invention and a fuel cell system provided with this liquid supply container.

### First Embodiment

A first embodiment will be described in terms of a case, as an example, where liquid fuel to be used in a fuel cell is stored within a liquid storage portion of a liquid supply container, and this liquid fuel is supplied to a liquid reception portion of the fuel cell.

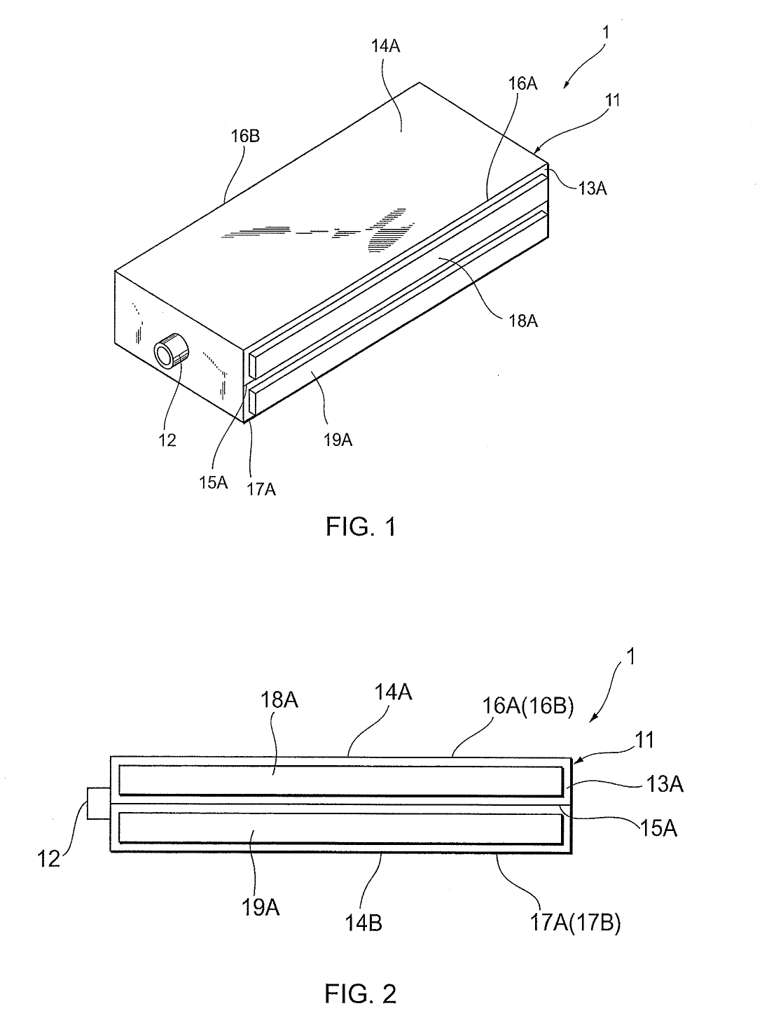

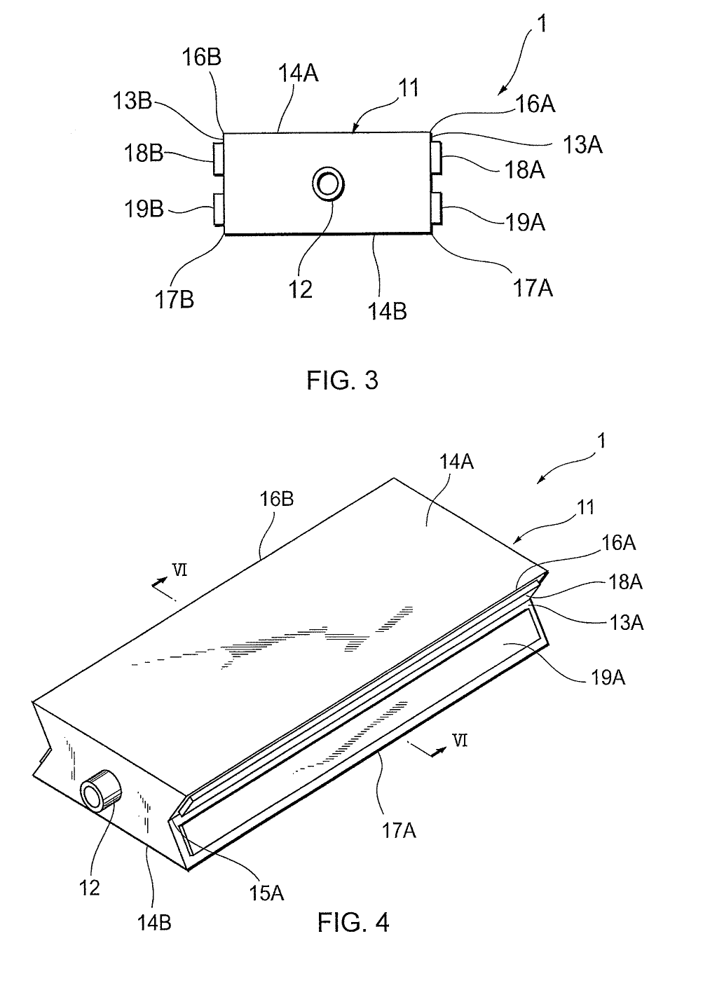

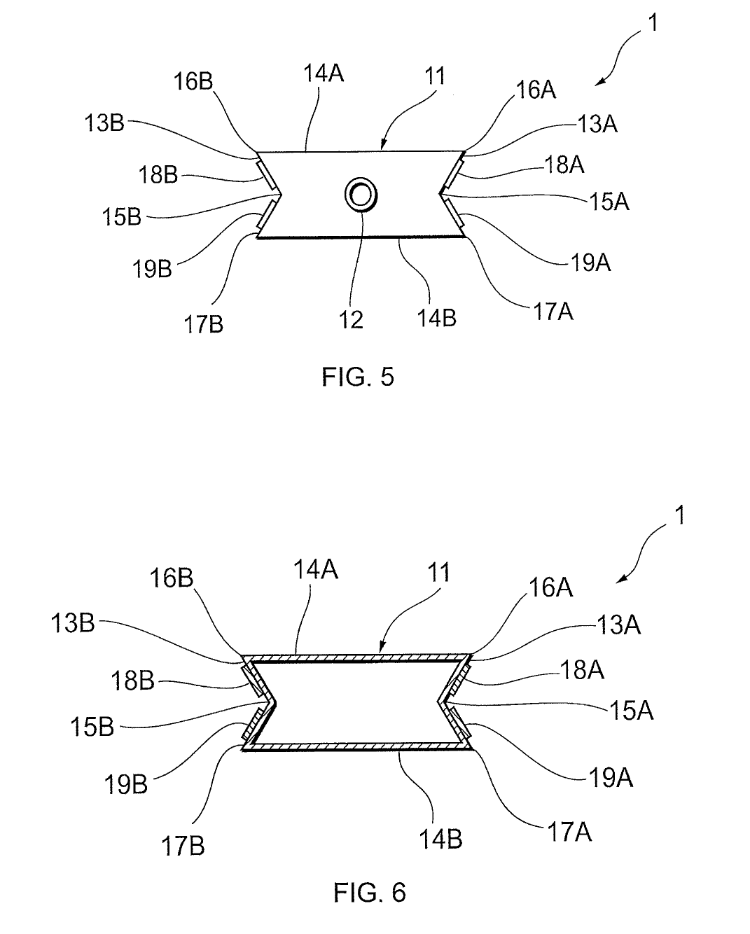

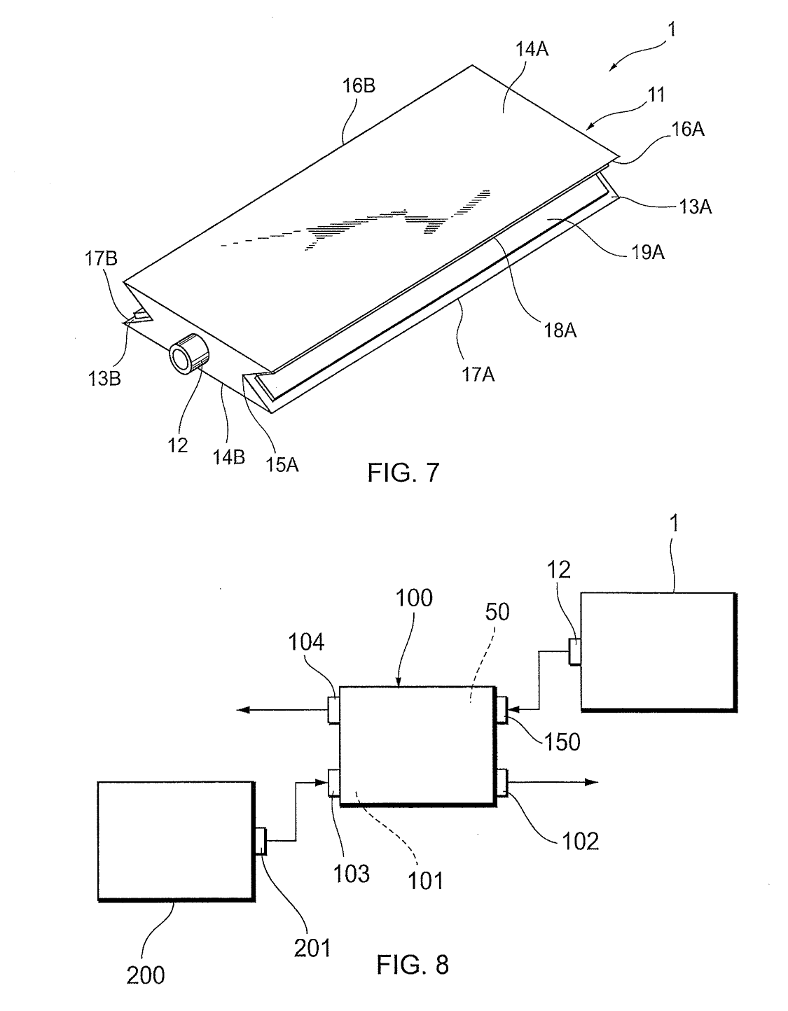

As shown in FIGS. 1 to 8, a liquid supply container 1 according to the first embodiment is configured to have a liquid storage portion 11 for storing liquid fuel in the inside thereof, and a supply port 12 provided in the liquid storage portion 11 for supplying the liquid fuel stored in the liquid storage portion 11 to a liquid reception portion 50 of a fuel cell 100 formed by a separate body.

The liquid storage portion 11 has a pair of side walls 13A and 13B arranged to face each other, and is formed by a bag which assumes a substantially rectangular parallelepiped shape when it is fully filled with the liquid fuel. The pair of side walls 13A and 13B have a gusseted structure. Specifically, as shown in FIGS. 4 to 7, the side walls 13A and 13B are each formed to be foldable inward of the liquid storage portion 11, in a substantially V-shape, such that fold lines 15A and 15B of the gusseted structure define the apexes of the V-shapes, respectively.

The side wall 13A has rigid members 18A and 19A arranged in an area between the fold line 15A of the gusseted structure and an edge 16A substantially parallel to the fold line 15A and in an area between the fold line 15A and an edge 17A substantially parallel to the fold line 15A, respectively. Like the side wall 13A, the side wall 13B also has rigid members 18B and 19B respectively arranged in an area between the fold line 15B of the gusseted structure and an edge 16B substantially parallel to the fold line 15B and in an area between the fold line 15B and an edge 17B substantially parallel to the fold line 15B. These rigid members 18A, 19A, 18B and 19B are arranged along a longitudinal direction of the side walls 13A and 13B.

The rigid members 18A and 19A and the rigid members 18B and 19B have functions to reinforce the side walls 13A and 13B when the side walls 13A and 13B are folded inward along the fold lines 15A and 15B to help efficient folding thereof, and to prevent the top wall 14A and the bottom wall 14 from being bent in a longitudinal direction. In the first embodiment, an ultraviolet curable resin layer is provided as the rigid members 18A, 19A, 18B and 19B. The ultraviolet resin layer can be formed by a simple process in which an ultraviolet resin is applied on the areas where the rigid member 18A, 19A, 18B and 19B are to be provided and irradiating the resin with ultraviolet light.

The supply port 12 is formed in a face wall different from the side walls 13A and 13B of the liquid storage portion 11 (in an end face in a longitudinal direction in the first embodiment). The supply port 12 is designed to open when connected to a liquid reception portion 50 and to prevent the liquid fuel stored in the liquid storage portion 11 from leaking out by accident.

The liquid supply container 1 having such configuration reduces the internal volume of the liquid storage portion 11 by the pair of side walls 13A and 13B being folded inward as the amount of liquid fuel stored in the liquid storage portion 11 is reduced (see FIGS. 4 to 7). Bing provided with the rigid members 18A and 19A and the rigid members 18B and 19B, respectively, the pair of side walls 13A and 13B can be folded easily as they are supported (reinforced) by the rigid members 18A and 19A and the rigid members 18B and 19B, respectively. Therefore, the internal volume of the liquid storage portion 11 can be reduced efficiently as the amount of the liquid fuel stored in the liquid storage portion 11 is reduced. When the supply of the liquid fuel stored in the liquid storage portion 11 to the liquid reception portion 50 is completed, the side walls 13A and 13B of the liquid storage portion 11 will have been folded substantially completely. This means that there is almost no space to contain the liquid fuel, and that the liquid fuel can be supplied to the liquid reception portion 50 without leaving much liquid fuel unused.

A description will be made on a case in which the liquid supply container according to the first embodiment is applied to a fuel cell system, with reference to FIG. 8.

A fuel cell system according to the first embodiment has a fuel cell 100, a liquid supply container 1 connected to an inlet port 150 of a liquid reception portion 50 for supplying fuel (liquid fuel in the first embodiment) to a fuel electrode of the fuel cell 100, and an oxygen gas supply source 200 connected to an inlet port 103 of an air supply portion 101 for supplying oxygen gas (usually air) to an air electrode of the fuel cell 100. The reference numeral 102 indicates an off-gas exhaust port for discharging off-gas out from the fuel electrode of the fuel cell 100, the reference numeral 104 indicates an off-gas exhaust port for discharging off-gas out from the air electrode of the fuel cell 100, and the reference numeral 201 indicates an oxygen gas injection port of the oxygen gas supply source 200.

Although, in FIG. 8, the supply port 12 of the liquid supply container 1 is connected to the inlet port 150 of the liquid reception portion 50 by an arrow for the sake of convenience, the supply port 12 and the inlet port 15 may be connected directly to each other, or may be connected through a connection member such as a pipe or tube. The same applies to connection between the oxygen gas injection port 201 and oxygen gas inlet port 103. The oxygen gas supply source 200 may be a storage container such as a tank storing oxygen gas, or air may be supplied directly from the atmosphere.

Various types of fuel cells can be used as the fuel cell 100. In the first embodiment, a DMFC is used as the fuel cell 100, and methanol is stored (contained) in the liquid storage portion 11 of the liquid supply container 1.

When power is generated by the fuel cell system having this configuration, the liquid fuel stored in the liquid storage portion 11 of the liquid supply container 1 is supplied to the liquid reception portion 50 via the supply port 12. The liquid fuel is supplied from the liquid storage portion 11 to the liquid reception portion 50, usually by being sucked by a pump or the like (not shown) provided in the fuel cell system. The fuel cell 100 generates power by means of an electrochemical reaction which occurs between hydrogen ions obtained from the liquid fuel supplied to the liquid reception portion 50 and oxygen supplied from the oxygen gas supply source 200 (or air introduced directly from the atmosphere).

The liquid fuel stored in the liquid storage portion 11 is consumed by the power generation and the amount of the liquid fuel in the liquid storage portion 11 is reduced. As described before, the internal volume of the liquid storage portion 11 can be reduced efficiently along with the reduction of the amount of the liquid fuel. Therefore, variation in pressure within the liquid storage portion 11 can be suppressed reliably during the supply of the liquid fuel stored in the liquid storage portion 11 to the liquid reception portion 50. Thus, in the case in which the liquid fuel stored in the liquid storage portion 11 is sucked by a pump or the like, the suction force of the pump or the like can be maintained constant and the increase in power consumption can be prevented.

When the supply of the liquid fuel stored in the liquid storage portion 11 to the liquid reception portion 50 is completed, the side walls 13A and 13B of the liquid storage portion 11 are substantially completely folded inward. Therefore, the liquid fuel can be supplied to the liquid reception portion 50 efficiently and the amount of liquid fuel remained in liquid storage portion 11 can be reduced, providing an economic benefit.

Although the description of the first embodiment has been made in terms of the case in which the liquid storage portion 11 is formed by a bag which assumes a substantially rectangular parallelepiped shape when it is fully filled with the liquid fuel, the present invention is not limit to this. The liquid storage portion 11 may have any other shape such as a cylindrical shape or a polygonal column shape such as triangular or quadrangular column as long as it has a pair of side walls 13A and 13B having a gusseted structure.

While the liquid storage portion 11 should, of course, be made of a material resistant to the liquid to be stored therein, the side walls 13A and 13B are desirably formed of a material that can be easily folded along with the reduction of the liquid. When liquid fuel (methanol) is stored as the liquid as in the first embodiment, for example, the liquid storage portion 11 may have a rectangular parallelepiped shape, or a polygonal column shape such as triangular or quadrangular column. The thickness of walls of the container forming the liquid storage portion 11 (bag in the first embodiment) can be determined as required.

Further, although the description of the first embodiment has been made in terms of the case in which the rigid members 18A, 19A, 18B and 19B are formed by an ultraviolet curable resin layer, the present invention is not limited to this. The rigid members 18A, 19A, 18B and 19B may be formed of any other material such as acrylic resin or epoxy resin as long as they can fulfill their functions to reinforce the side walls 13A and 13B and to enable the side walls 13A and 13B to be folded efficiently and reliably. Further, the rigid members 18A, 19A, 18B and 19B may be formed integrally with the side walls 13A and 13B or formed as separated members and attached to the side walls 13A and 13B by means of an adhesive or the like.

Still further, although the description of the first embodiment has been made in terms of the case in which the rigid members 18A, 19A, 18B and 19B are arranged along a longitudinal direction over the entire surfaces of the side walls 13A and 13B (except areas in the vicinity of the fold lines 15A and 15B), the present invention is not limited to this. The rigid members 18A, 19A, 18B and 19B may be arranged at any desired position and in any desired size on the side walls 13A and 13B. Further, the rigid members 18A, 19A, 18B and 19B may have any desired thickness (wall thickness).

Still Further, although the description of the first embodiment has been made in terms of the case in which the liquid fuel for use in the fuel cell 100 is stored in the liquid storage portion 11, the present invention is not limited to this. It should be understood that the liquid to be stored in the liquid storage portion 11 can be selected arbitrarily.

### Second Embodiment

A liquid supply container according to a second embodiment of the present invention will be described with reference to the drawings. In the description of the second embodiment, like members to those described in the first embodiment will be designated with like reference numerals, and detailed description will be omitted.

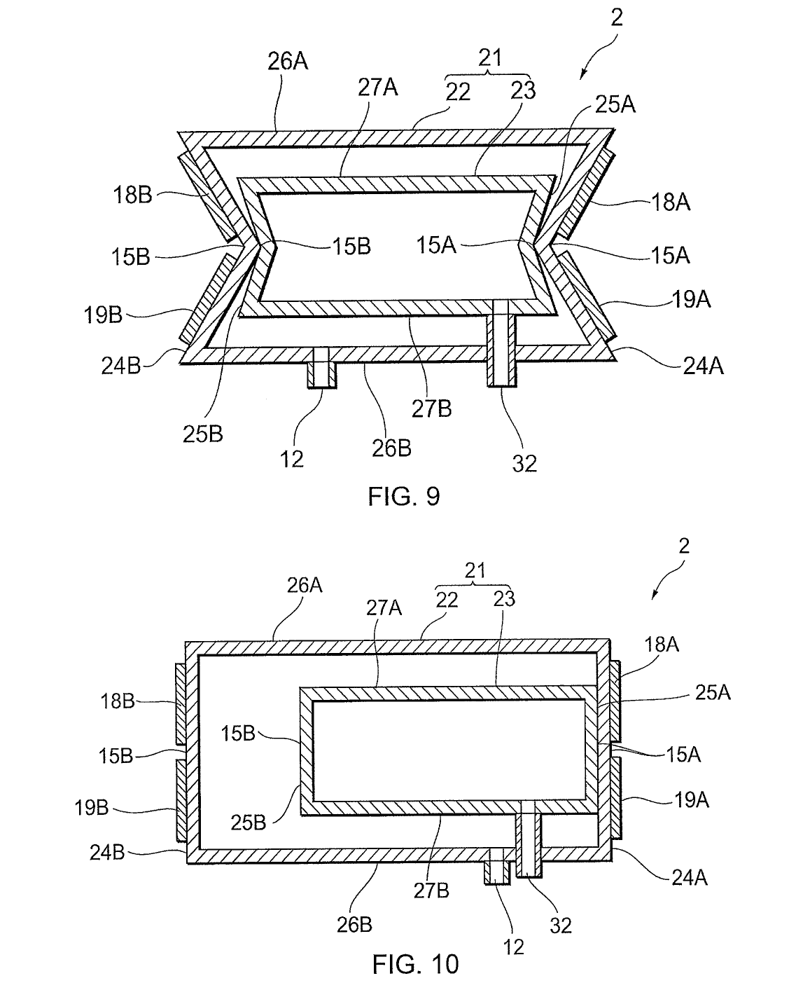

As shown in FIG. 9, a liquid supply container 2 according to the second embodiment is different from the liquid supply container 1 according to the first embodiment principally in that its liquid storage portion 21 is formed by two liquid storage chambers 22 and 23.

The liquid storage portion 21 has a multiple cylinder structure in which the liquid storage chamber 23 is arranged within the liquid storage chamber 22. This means that walls defining the liquid storage chamber 23 function as partition walls partitioning the inside of the liquid storage chamber 22.

The liquid storage chamber 22 has a pair of side wall 24A and 24B arranged to face each other, and is formed by a bag which assumes a substantially rectangular parallelepiped shape when it is fully filled with liquid fuel. The pair of side walls 24A and 24B have a gusseted structure. Like the side walls 13A and 13B described in the first embodiment, the side walls 24A and 24B are each formed to be foldable inward of the liquid storage portion 22, in a substantially V-shape, such that fold lines 15A and 15B of the gusseted structure define the apexes of the V-shapes, respectively. Like the first embodiment, these side walls 24A and 24B are respectively provided with rigid members 18A, 19A, 18B and 19B. Further, a supply port 12 is provided in a wall which is different from the side walls 24A and 24B of the liquid storage chamber 22 and extends in a longitudinal direction.

The liquid storage chamber 23 has such a size as to be accommodatable within the liquid storage chamber 22, and defines an enclosed space isolated from the liquid storage chamber 22 by being accommodated within the liquid storage chamber 22. This liquid storage chamber 23 has a pair of side walls 25A and 25B arranged to face each other, and is formed by a bag which assumes a substantially rectangular parallelepiped shape when it is fully filled with liquid fuel. The pair of side walls 25A and 25B have a gusseted structure. Like the side walls 13A and 13B described in the first embodiment, these side walls 25A and 25B are each formed to be foldable inward of the liquid storage chamber 23, in a substantially V-shape, such that fold lines 15A and 15B of the gusseted structure define the apexes of the V-shapes, respectively. The liquid storage chamber 23 may be such that the part(s) thereof corresponding to the fold line 15A and/or the fold line 15B is/are fixed to the part(s) of the liquid storage chamber 22 corresponding to the fold line 15A and/or the fold line 15B.

Further, a supply port 32 is provided in a wall which is different from the side walls 25A and 25B of the liquid storage chamber 23 and extends in a longitudinal direction. This supply port 32 has the same function as that of the supply port 12, and has a length long enough to extend to the outside, passing through the liquid storage chamber 22. The supply port 32 is sealed with respect to the liquid storage chamber 22.

The liquid supply container 2 configured as described above is capable of storing various different types of liquid fuel in the liquid storage chamber 22 and the liquid storage chamber 23, respectively. Therefore, either the liquid fuel stored in the liquid storage chamber 22 or the liquid fuel stored in the liquid storage chamber 23 can be selected depending on the situation and supplied to the liquid reception portion 50 (see FIG. 8) via the supply port 12 or the supply port 32. Since the side walls 24A and 24B of the liquid storage chamber 22 are formed in a gusseted structure and provided with the rigid members 18A, 19A, 18B and 19B, the side walls 24A and 24B are folded up gradually along with the reduction of the amount of the liquid fuel stored in the liquid storage chamber 22. Thus, like the first embodiment, the internal volume of the liquid storage chamber 22 can be reduced efficiently.

Since the side walls 25A and 25B of the liquid storage chamber 23 are also formed in a gusseted structure, the side walls 25A and 25B are folded up gradually along with the reduction of the amount of the liquid fuel stored in the liquid storage chamber 23. Thus, the internal volume of the liquid storage chamber 23 also can be reduced efficiently. This makes it possible to reliably suppress the variation in pressure within the liquid storage chambers 22 and 23 when the liquid fuel stored in the liquid storage chambers 22 and 23 is supplied to the liquid reception portion 50, and to reduce the amount of the liquid remaining within the liquid storage chambers 22 and 23 at the time when the supply of the liquid fuel stored in the liquid storage chambers 22 and 23 to the liquid reception portion 50 is completed.

Although the description of the second embodiment has been made in terms of the case in which no rigid members 18A, 19A, 18B and 19B are provided on the side walls 25A and 25B of the liquid storage chamber 23, the present invention is not limited to this. The side walls 25A and 25B of the liquid storage chamber 23 may also be provided with the rigid members 18A, 19A, 18B and 19B. This makes it possible to reduce the internal volume of the liquid storage chamber 23 even more efficiently along with the reduction of the liquid fuel stored in the liquid storage chamber 23.

Although the description of the second embodiment has been made in terms of the case in which the liquid storage portion 21 has a multiple cylinder structure (double cylinder structure) in which the liquid storage chamber 23 is arranged within the liquid storage chamber 22, the present invention is not limited to this. The liquid storage portion 21 may have a triple or more cylinder structure in which another liquid storage chamber is arranged within the liquid storage chamber 23, for example.

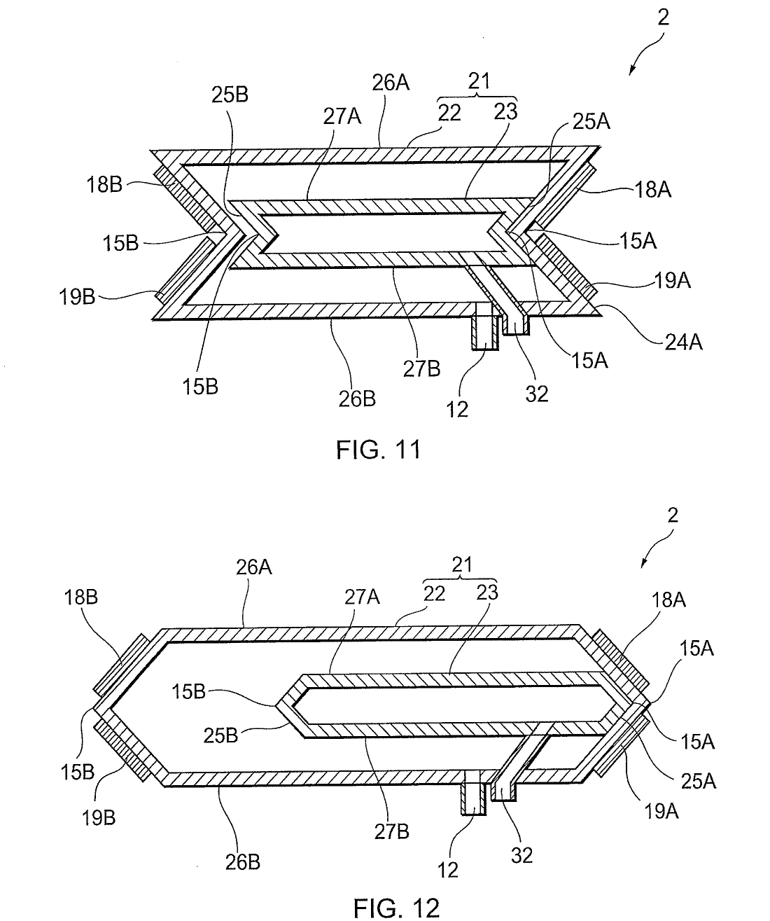

Further, although the description of the second embodiment has been made in terms of the case in which the parts corresponding to the fold lines 15A and 15B of the side walls 25A and 25B of the liquid storage chamber 23 are fixed to the parts corresponding to the fold lines 15A and 15B of the side walls 24A and 24B of the liquid storage chamber 22, the present invention is not limited to this. As shown in FIG. 10, for example, one of the side walls 25A and 25B of the liquid storage chamber 23 may be fixed to the side wall 24A (24B) of the liquid storage chamber 22. In this case, as shown in FIG. 11, the design may be such that the side walls 24A and 24B of the liquid storage chamber 22 are each folded inward of the liquid storage chamber 22, in a substantially V-shape, such that the fold lines 15A and 15B of the side walls 24A and 24B of the liquid storage chamber 22 define the apexes of the V-shapes, while the side walls 25A and 25B of the liquid storage chamber 23 are each folded inward of the liquid storage chamber 23, in a substantially V-shape, such that the fold lines 15A and 15B of the side wall 25A and 25B define the apexes of the V-shapes. Alternatively, as shown FIG. 12, the design may be such that the side walls 24A and 24B of the liquid storage chamber 22 and the side walls 25A and 25B of the liquid storage chamber 23 are each folded outward of the liquid storage chambers 22 and 23, in a substantially V-shape, such that the fold lines 15A and 15B thereof define the apexes of the V-shapes. When the designs as shown in FIGS. 11 and 12 are employed, the supply port 32 is formed of a deformable flexible material. The designs shown in FIGS. 11 and 12 are also applicable to the liquid storage portion 11 according to the first embodiment.

Still further, although the description of the second embodiment has been made in terms of the case in which the liquid storage chambers 22 and 23 are each formed by a bag which assumes a substantially rectangular parallelepiped shape when it is fully filled with liquid fuel, the present invention is not limited to this. Like the first embodiment, the liquid storage chambers 22 and 23 may have any other shape as long as they have a pair of side walls 24A and 24B, 25A and 25B with a gusseted structure.

### Third Embodiment

A liquid supply container according to a third embodiment of the present invention will be described with reference to the drawings. In the description of the third embodiment, like members to those described in the first and second embodiments will be designated with like reference numerals, and detailed description will be omitted.

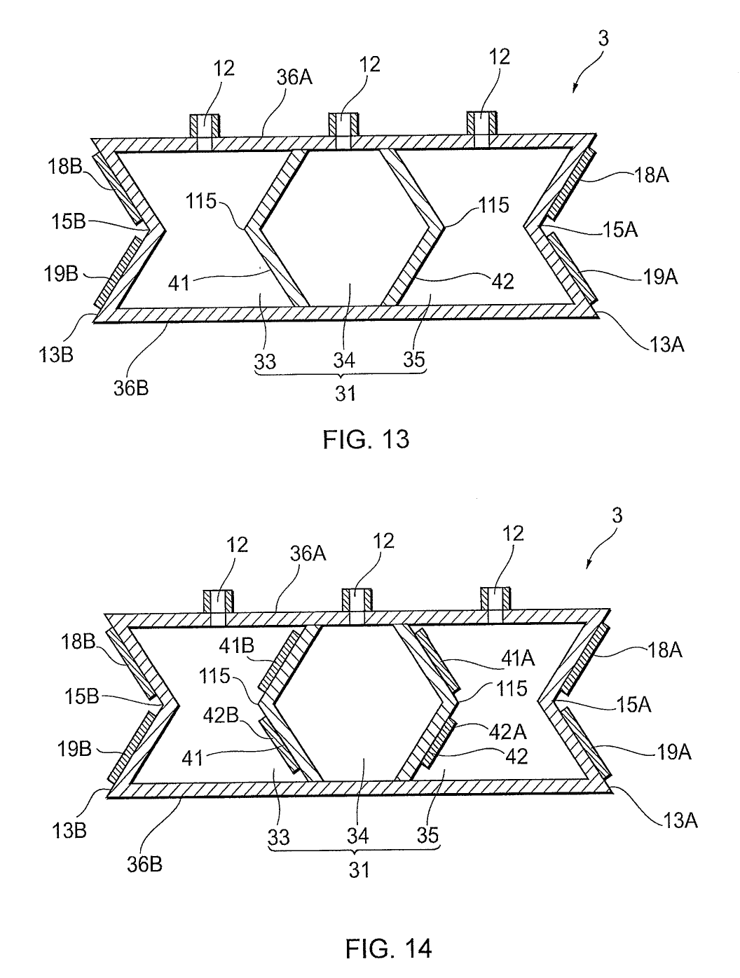

As shown in FIG. 13, a liquid supply container 3 according to the third embodiment is principally different from the liquid supply container 1 of the first embodiment in that its liquid storage portion 31 is composed of three liquid storage chambers 33, 34 and 35.

The liquid storage portion 31 has a pair of side walls 13A and 13B arranged to face each other, and is formed by a bag which assumes a substantially rectangular parallelepiped shape when it is fully filled with liquid fuel. Like the first embodiment, this pair of side walls 13A and 13B are provided with rigid members 18A, 19A, 18B and 19B. Partition walls 41 and 42 are arranged within the liquid storage portion 31 to partition the inside thereof, and thus the liquid storage portion 31 is divided into three mutually isolated liquid storage chambers 33, 34 and 35 by these partition walls 41 and 42. The liquid storage chambers 33, 34 and 35 are each provided with a supply port 12.

The partition wall 41 is arranged to face the side wall 13B such that the liquid storage chamber 33 is separated from the liquid storage chamber 34. The partition wall 41 is formed to be symmetric with the side wall 13B (formed similar to the side wall 13A). Specifically, the partition wall 41 has a gusseted structure in which a fold line 115 of the gusseted structure is folded inward of the liquid storage chamber 33, in a V-shape, such that the fold line 115 defines the apex of the V-shape.

The partition wall 42 is arranged to face the side wall 13A such that the liquid storage chamber 34 is separated from the liquid storage chamber 35. The partition wall 42 is formed symmetric with the side wall 13A (formed similar to the side wall 13B). Specifically, the partition wall 42 has a gusseted structure in which a fold line 115 of the gusseted structure is folded inward of the liquid storage chamber 35, in a V-shape, such that the fold line 115 defines the apex of the V-shape.

The liquid supply container 3 configured in this manner is capable of storing various different types of liquid fuel in the liquid storage chambers 33, 34 and 35, respectively. As a result, one of these types of liquid fuel stored in the liquid storage chambers 33, 34 and 35 can be selected depending on the situation and supplied to the liquid reception portion 50 (see FIG. 8) through the supply port 12 arranged in relevant one of the liquid storage chambers 33, 34 and 35. Since the side walls 13A and 13B of the liquid storage portion 31 are formed in a gusseted structure, being provided with the rigid members 18A, 19A, 18B and 19B, and more over the partition walls 42 and 43 are also formed in a gusseted structure, the side walls 13A and 13B, and the partition walls 41 and 42 are folded up gradually along with the reduction of the amount of liquid fuel stored in the liquid storage chambers 33, 34 and 35, whereby the internal volumes of the liquid storage chambers 33, 34 and 35 can be reduced as efficiently as the first embodiment. This makes it possible to reliably suppress the variation in pressure within the liquid storage chambers 33, 34 and 35 during the supply of the liquid fuel stored in the liquid storage chambers 33, 34 and 35 to the liquid reception portion 50, and to reduce the amount of the liquid remaining in the liquid storage chambers 33, 34 and 35 after completion of the supply of the liquid fuel stored in the liquid storage chambers 33, 34 and 35 to the liquid reception portion 50.

Although no rigid members are provided on the partition walls 41 and 42 shown in FIG. 13, the partition walls 41 and 42 may be provided with rigid members 41A, 42A, 41B and 42B as shown in FIG. 14. This makes it possible to reduce the internal volumes of the liquid storage chambers 33, 34 and 35 even more efficiently along with the reduction of the amount of liquid fuel stored in the liquid storage chambers 33, 34 and 35.

Although the description of the third embodiment has been made in terms of the case in which the inside of the liquid storage portion 31 is divided into three liquid storage chambers 33, 34 and 35, the present invention is not limited to this. The inside of the liquid storage portion 31 may be divided into two chambers by a single partition wall, or may be divided into four or more chambers by three or more partition walls.

Further, although the description of the third embodiment has been made in terms of the case in which the liquid storage portion 31 is formed by a bag which assumes a substantially rectangular parallelepiped shape when it is fully filled with liquid fuel, the present invention is not limited to this. Like the first embodiment, the liquid storage portion 31 may have any other shape as long as it has a pair of side walls 13A and 13B having a gusseted structure.

In the first to third embodiments, the rigid members may be provided, for example, on the top walls 14A, 26A, 27A and 36A, or on the bottom walls 14B, 26B, 27B and 36B. The provision of the rigid members on these walls makes it possible to reduce the internal volume in a more stable manner.

The liquid supply containers as described in the first to third embodiments are designed such that a pair of side walls are folded to reduce the internal volume of the liquid storage portion as the amount of liquid stored in the liquid storage portion is reduced. Since the side walls are supported (reinforced) by the rigid members, they can be folded even more easily. Thus, the internal volume of the liquid storage portion can be reduced in accordance with the reduction of the amount of liquid stored in the liquid storage portion. This makes it possible to reliably suppress the variation in pressure within the liquid storage portion when the liquid stored in the liquid storage portion is supplied to the liquid receptor. In addition, when the supply of the liquid stored in the liquid storage portion to the liquid receptor is completed, the side walls of the liquid storage portion are folded up substantially completely. Therefore, there remains substantially no space to contain the liquid. This makes it possible to reduce the amount of the liquid remaining in the liquid storage portion after completion of the supply of the liquid to the liquid receptor. As a result, the liquid stored in the liquid storage portion can be used up without leaving any liquid unused.

The liquid supply container as described above may include a plurality of partition walls for dividing the inside of the liquid storage portion into a plurality of liquid storage chambers, each of the partition walls having a gusseted structure which is folded when a pair of side walls are folded, and a supply port may be connected to each of the plurality of liquid storage chambers. According to this configuration, various different types of liquid can be stored respectively in the liquid storage chambers, so that an optimal liquid can be selected from the plural types of liquid depending on desired conditions such as usage environment or the like, and supplied to the liquid receptor via the supply port provided in the relevant liquid storage chamber. Since the partition walls are also provided with a gusseted structure which is folded in the same manner as the pair of side walls of the liquid storage portion, the internal volume of the liquid storage portion can be reduced in accordance with the reduction of the amount of the liquid stored in the liquid storage chamber. This makes it possible to reliably suppress the variation in pressure within the liquid storage chamber when the liquid stored in the liquid storage portion is supplied to the liquid receptor, and to reduce the amount of the liquid remaining in the liquid storage chamber after completion of the supply of the liquid stored in the liquid storage chamber to the liquid receptor.

In the liquid supply container described above, a plurality of liquid storage chambers may be arranged to form a multiple cylinder structure. In addition to the advantages described above, this configuration offers advantages over the case in which a plurality of bags are accommodated within the liquid storage portion for storing various different types of liquid. Specifically, the waste of storing space can be reduced and thus the internal space of the liquid storage portion can be used even more efficiently. As a result, the capacity ratio of the liquid storage portion to the entire liquid supply container can be improved further.

In the liquid supply container described above, a rigid member may be arranged on the partition wall between the fold line of the gusseted structure and an edge substantially parallel to the fold line. According to this configuration, since the partition wall is also supported (reinforced) by the rigid member, the folding can be performed even more easily. This makes it possible to reliably suppress the variation in pressure within the liquid storage chamber when the liquid stored in the liquid storage portion is supplied to the liquid receptor. Moreover, there is substantially no space to contain the liquid when completing the supply of the liquid stored in the liquid storage chamber to the liquid receptor, and thus the amount of the liquid remaining in the liquid storage chamber can be reduced.

In the liquid supply container described above, the rigid members may be formed of an ultraviolet curable resin layer. This facilitates the arrangement work of the rigid members, and prevents the increase of manufacturing cost. A well-known ultraviolet curable resin such as acrylic resin or epoxy resin can be used for this purpose.

The fuel cell system as described above is capable of reducing the internal volume of the liquid storage portion efficiently along with the reduction of the amount of liquid fuel stored in the liquid storage portion of the liquid supply container, and substantially eliminating the space in the liquid storage portion where the liquid fuel can be contained when completing the supply of the liquid fuel stored in the liquid storage portion to the liquid receptor. As a result, the variation in pressure within the liquid storage portion can be suppressed reliably when the liquid fuel stored in the liquid storage portion is supplied to the liquid receptor, and thus when the liquid fuel stored in the liquid storage portion is supplied to the liquid receptor by means of a pump, for example, the load imposed on the pump can be reduced. This makes it possible to reduce the power consumption required to supply the liquid fuel to the liquid receptor, and to use up the liquid fuel stored in the liquid storage portion very economically without leaving much liquid fuel unused.

It should be understood that the foregoing relates to only preferred exemplary embodiments for explaining the present invention, and that the present invention is not limited to these embodiments but may be otherwise variously embodied without departing from the sprit and scope of the invention.

This application is based upon and claims the benefit of priority from Japanese Patent Application No. 2006-186028, filed Jul. 5, 2006, the disclosure of which is incorporated herein in its entirety by reference.

1. A liquid supply container comprising
a liquid storage portion for storing liquid therein, the liquid storage portion comprising a pair of side walls arranged to face each other, each of the side walls being of a gusseted structure which has opposite edges and a fold line between the opposite edges;
a supply port for supplying the liquid from the liquid storage portion to an object, the supply port being provided in a wall which is included in the liquid storage portion and different from the side walls of; and
at least one rigid member coupled to at least one of the side walls between the fold line and at least one of the edges.

2. The liquid supply container according to claim 1, further comprising a partition wall partitioning the inside of the liquid storage portion into a plurality of liquid storage chambers, wherein the partition wall is of a gusseted structure and is folded when the pair of side walls are folded, and the supply port is connected to each of the liquid storage chambers.

3. The liquid supply container according to claim 2, wherein the liquid storage chambers are arranged to form a multiple cylinder structure.

4. The liquid supply container according to claim 2 further comprising a rigid member arranged on the partition wall between the fold line of the partition wall and an edge of the partition wall.

5. The liquid supply container according to claim 1, wherein the at least one rigid member is formed of an ultraviolet curable resin layer.

6. The liquid supply container according to claim 1, wherein the liquid is liquid fuel for use in fuel cells.

7. A fuel cell system comprising:
the liquid supply container according to claim 1;
liquid fuel stored in the liquid supply container; and
a fuel cell for generating power by using the liquid fuel supplied from the liquid supply container.

8. The fuel cell system according to claim 7, wherein the fuel cell has a liquid receptor for storing the liquid fuel.

9. The fuel cell system according to claim 7, further comprising an oxygen gas supply source for supplying oxygen gas to the fuel cell.
